(19) United States
(12) Patent Application Publication
(10) Pub. No.: US 2005/0195997 A1
(43) Pub. Date: Sep. 8, 2005

(54) Audio mixer

(75) Inventor: Tony Yang, Taichung (TW)

Correspondence Address: BACON & THOMAS, PLLC, 625 SLATERS LANE, FOURTH FLOOR, ALEXANDRIA, VA, 22314, US

(73) Assignee: SEKAKU ELECTRON INDUSTRY CO., LTD., TAICHUNG (TW)

(21) Appl. No.: 10/793,809

(22) Filed: Mar. 8, 2004

(51) Int. Cl. H04B 1/00; H04B 1/20

(52) U.S. Cl. 381/119; 369/4

(57) ABSTRACT

An audio mixer includes a console, which has a base with an indication face, and different sizes of mounting holes and knob holes, a sound signal processing unit mounted inside the console, a sound signal input zone, which defines multiple sound signal input blocks and has connectors respectively mounted in the sound signal input blocks corresponding to the mounting holes of the console, a sub-control zone, which divides multiple sub-control blocks and has sub-control knobs respectively mounted in the sub-control blocks and the knob holes of the console and electrically connected to the sound signal processing unit, and a main control zone, which defines a main control block, and has an indication provided in the main control block and a main control knob greater in size than the sub-control knobs and electrically connected to the sound signal processing unit and disposed above the indication face of the console.

### BACKGROUND OF THE INVENTION

1. Field of the Invention

The present invention relates generally to sound producing apparatus and more particularly, to an audio mixer for sound producing system.

2. Description of the Related Art

A regular audio mixer has a number of knobs for different adjustments. However, because these knobs have a similar outer appearance and are set one close to another, the user may operate the wrong knob or waste a lot of time to select the correct knob during operation.

Further, these knobs may be designed in the form of a sliding switch that must be moved with the fingers within a long distance. There are small rotary knobs for volume and other function controls. However the user may not be able to distinguish these small rotary knobs from one another at a glance. When turning the small rotary knob for volume control, the user may achieve the adjustment accurately after several trials.

Therefore, it is desirable to provide an audio mixer that eliminates the aforesaid drawbacks.

### SUMMARY OF THE INVENTION

The present invention has been accomplished under the circumstances in view. It is the main object of the present invention to provide an audio mixer for sound control system, which enables the user to conveniently visually identify the controls. It is another object of the present invention to provide an audio mixer for sound control system, which is convenient for operation to mix sounds. It is still another object of the present invention to provide an audio mixer for sound control system, which has a console that causes a sense of beauty.

To achieve these and other objects of the present invention, the audio mixer for sound control system comprises a console, the console having a base, an indication face on a top side of the base, a receiving chamber, and different sizes of mounting holes and knob holes; a sound signal processing unit installed in the receiving chamber of the console; a sound signal input zone, having a plurality of sound signal input blocks, and a plurality of connectors respectively mounted in the sound signal input blocks corresponding to the mounting holes of the console; a sub-control zone, the sub-control zone having plurality of sub-control blocks, a plurality of sub-control knobs respectively mounted in the sub-control blocks and the knob holes of the console and electrically connected to the sound signal processing unit; and a main control zone, the main control zone having a main control block, an indication provided in the main control block, a main control knob electrically connected to the sound signal processing unit and disposed above the indication face of the console, the main control knob having an outer diameter greater than the diameter of the sub-control knobs of the sub-control zone.

### BRIEF DESCRIPTION OF THE DRAWINGS

FIG. 1 is a top view of an audio mixer for sound control system according to the present invention.

FIG. 2 is similar to FIG. 1 but showing an operation status of the audio mixer.

FIG. 3 is a printed view of the console of the audio mixer according to the present invention.

FIG. 4 is a sectional view taken along line 4-4 of FIG. 4.

FIG. 5 is similar to FIG. 4 but showing another main control knob.

### DETAILED DESCRIPTION OF THE INVENTION

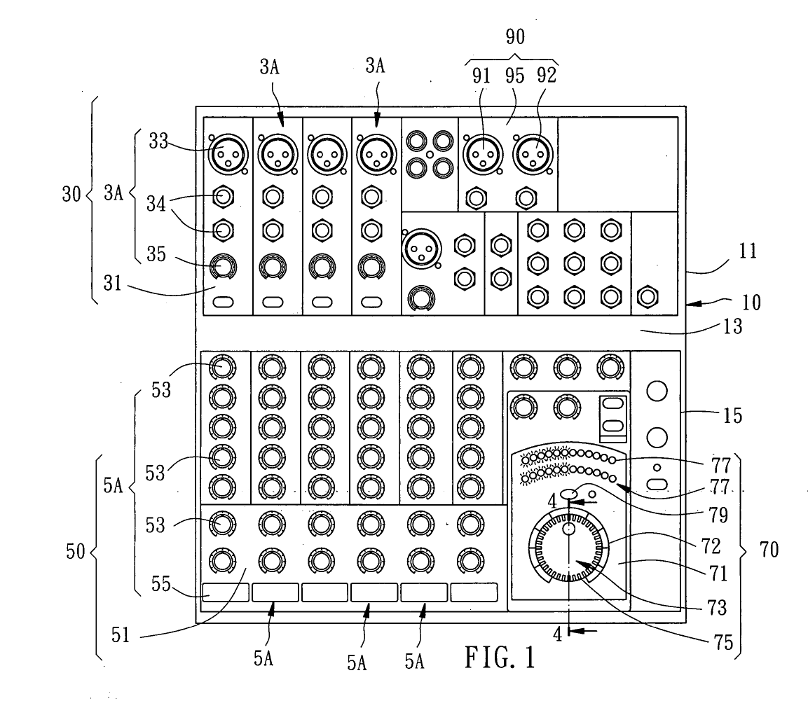

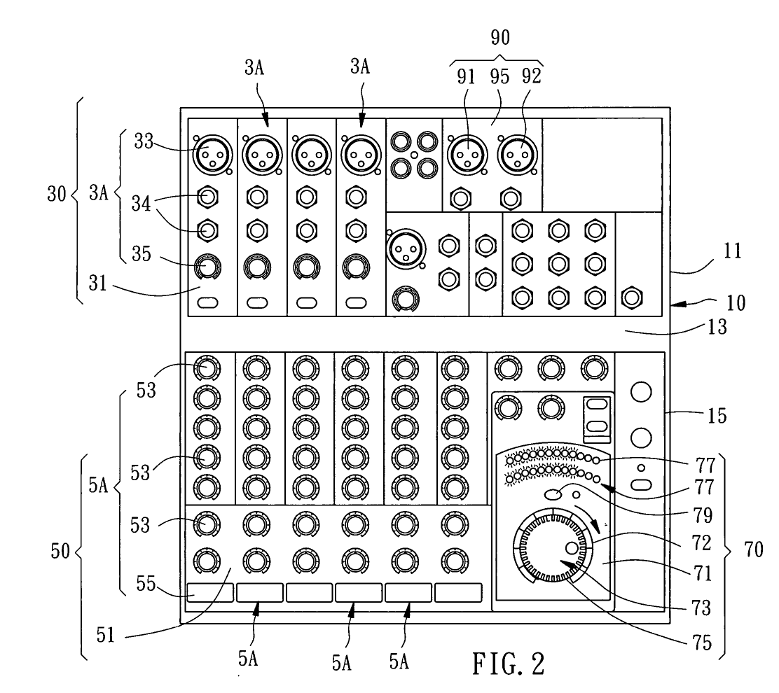

Referring to FIGS. 1˜4, an audio mixer for sound control system is shown comprising:
A console 10, which has a base 11, an indication face 13 on the top side of the base 11, a receiving chamber 15, and different sizes of mounting holes and knob holes (not shown);
A sound signal processing unit (not shown) installed in the receiving chamber 15 of the console 10 (because the sound signal processing unit is of the know art, no further detailed description in this regard is necessary);
A sound signal input zone 30, which has a plurality of sound signal input blocks 31, a plurality of connectors 33 and 34 for MIC and LINE respectively mounted in the sound signal input blocks 31 corresponding to the mounting holes of the console 10, and a plurality of input knobs 35, wherein the connectors 33 and 34 and the input knobs 35 form 8 input groups 3A;
A sub-control zone 50, which has a plurality of sub-control blocks 51, a plurality of sub-control knobs 53 for LEVEL, PAN, AUX, and EQ respectively mounted in the sub-control blocks 51 and the knob holes of the console 10 and electrically connected to the sound signal processing unit, wherein the sub-control knobs 53 form 8 adjustment groups 3A corresponding to the input groups 3A for sound field control;
A main control zone 70, which has a main control block 71, an indication 72 mounted in the main control block 71, a main control knob 73 electrically connected to the sound signal processing unit and disposed above the indication face 13 of the console 10, a set of sound volume indication lights 77 formed of light emitting diodes and arranged into two arched lines in the main control block 71 round the main control knob 73, wherein the main control knob 73 has a recessed portion 74 which formed a finger positioning portion and an embossed pattern 75 around the recessed portion 74 for the positioning of the finger to rotate the main control knob 73, and wherein the main control knob 73 has an outer diameter greater than or at least two times over the diameter of the sub-control knobs 53 of the sub-control zone 50; and
A sound signal output zone 90, which has a sound signal output block 95, and a first connector 91 and a second connector 92 mounted in the sound signal output block 95 and upwardly protruded over the base 11 of the console 10 for signal output.

Other control members may be added to the audio mixer as desired. Because other control members are not within the scope of the claims of the present invention, no further detailed description is necessary in this regard.

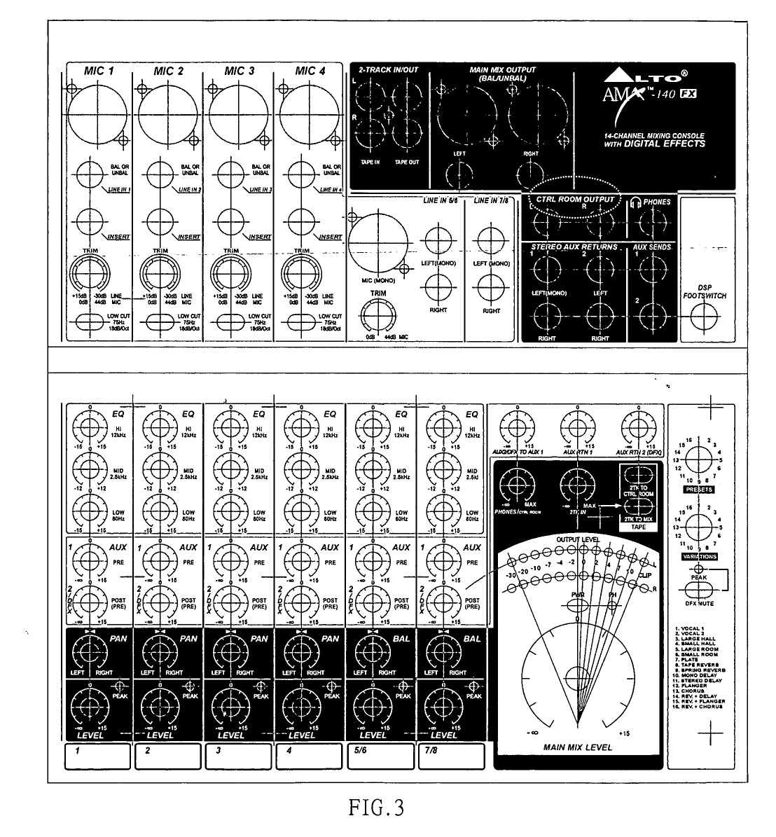

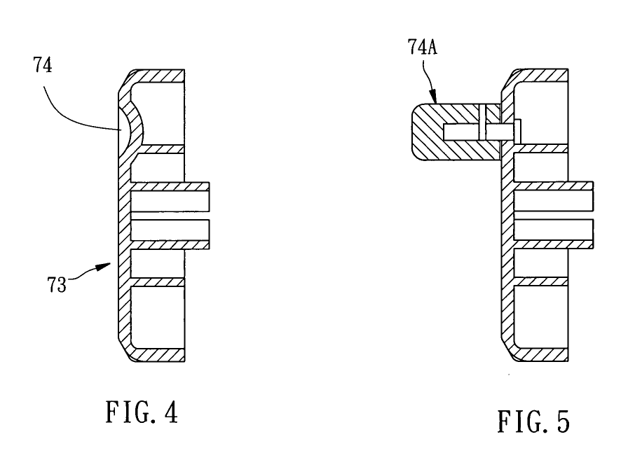

Referring to FIG. 3, the blocks of the sound signal input zone 30, sub-control zone 50, main control zone 70 and sound signal output zone 90 have different shapes or sizes and colored with different colors for quick identification by sight. Therefore, the operator can quickly find out the correct knob subject to the desired control.

It is to be understood that various modifications and changes may be made without departing from the spirit and scope of the invention. For example, the sound volume indication lights of the main control zone may be arranged into straight lines; the main control knob of the main control zone may be made having a raised portion instead of the aforesaid recessed portion; the main control knob of the main control zone may be provided with a handle 74A as shown in FIG. 5 for easy control.

In general, the audio mixer of the present invention has the following characteristics:
1. The control knobs of the audio mixer are so arranged that the operator can visually distinguish the control knobs from one another for quick control.

2. The arrangement and size designs of the control knobs of the audio mixer facilitate smooth sound mixing control operation.

3. The audio mixer is divided into different blocks colored with different colors, causing a sense of beauty.

1. An audio mixer comprising:
a console, said console having a base, an indication face on a top side of said base, a receiving chamber, and different sizes of mounting holes and knob holes;
a sound signal processing unit installed in the receiving chamber of said console;
a sound signal input zone, having a plurality of sound signal input blocks, and a plurality of connectors respectively mounted in said sound signal input blocks corresponding to the mounting holes of said console;
a sub-control zone, said sub-control zone having plurality of sub-control blocks, a plurality of sub-control knobs respectively mounted in said sub-control blocks and the knob holes of said console and electrically connected to said sound signal processing unit; and
a main control zone, said main control zone having a main control block, an indication provided in said main control block, a main control knob electrically connected to said sound signal processing unit and disposed above the indication face of said console, said main control knob having an outer diameter greater than the diameter of said sub-control knobs of said sub-control zone.

2. The audio mixer as claimed in claim 1, wherein said main control zone further has a set of sound volume indication lights.

3. The audio mixer as claimed in claim 2, wherein said sound volume indication lights are arranged into arched lines in said main control block round said main control knob.

4. The audio mixer as claimed in claim 2, wherein said sound volume indication lights are arranged into two lines.

5. The audio mixer as claimed in claim 1, wherein said main control knob of said main control zone has a handle for turning by hand.

6. The audio mixer as claimed in claim 1, wherein said main control knob of said main control zone has a finger positioning portion.

7. The audio mixer as claimed in claim 6, wherein said finger positioning portion of said main control knob is a raised portion protruded from a top surface thereof.

8. The audio mixer as claimed in claim 6, wherein said finger positioning portion of said main control knob is a recessed portion curved inwards in a top surface of said main control knob.

9. The audio mixer as claimed in claim 1, wherein said main control zone and said sub-control zone are colored with different colors.

10. The audio mixer as claimed in claim 1, further comprising a sound signal output zone provided at a top side of said console.
